(19) United States
(12) Patent Application Publication
(10) Pub. No.: US 2026/0100409 A1
(43) Pub. Date: Apr. 9, 2026

(54) Rechargeable Solid-State Dual-Pole Aluminum-Ion Cell

(71) Applicant: Olurinde Ebenezer Lafe, Bentleyville, OH (US)

(72) Inventor: Olurinde Ebenezer Lafe, Bentleyville, OH (US)

(73) Assignee: Fuel Cells Global LTD, Bentleyville, OH (US)

(21) Appl. No.: 18/907,543

(22) Filed: Oct. 6, 2024

(51) Int. Cl. H01M 10/0561; H01M 4/38; H01M 4/587; H01M 10/054; H01M 50/107; H01M 50/213; H01M 50/509

(52) U.S. Cl. CPC H01M 10/0561; H01M 4/38; H01M 4/587; H01M 10/054; H01M 50/107; H01M 50/213; H01M 50/509; H01M 2300/002; H01M 2300/0085

(57) ABSTRACT

A method and apparatus for storing electricity using a rechargeable electrochemical dual-pole-cell with a coiled aluminum wire disc as the anode, graphite-based sheets as cathodes, and solid electrolyte discs. The invention teaches the use of inexpensive materials, simplified dual-pole-cell construction, assembling of dual-pole-cells into power modules, and power modules into battery power packs.

### REFERENCES

Archer, L., Das, S. & Navaneedhakrishman, 2014. Aluminum Ion Battery Including Metal Sulfide or Monocrystalline Vanadium Oxide Cathode and Ionic Liquid Based Electrolyte. United States of America, US20140242457.
Azimi, G. & Ng, K. L., 2023. Aluminum-Ion Battery Using Aluminum Chloride/Trimethylamine Ionic Liquid As Electrolyte. United States of America, US20230104025.
Bockstie, L., Trevethan, D. & Zaromb, S., 1963. Control of Al corrosion in caustic solutions. Journal of The Electrochemical Society, 110 (4), pp. 267-271.
Caban-Acevado, M. & Yushin, G., 2023. Rechargeable Batteries With Alkali Metal Ion Cathodes, Aluminum Metal-Based Anodes And Displacement Electrolyte. United States of America, US20230411595.
Craig, B., Schoetz, T., Cruden, A. & Ponce de Leon, C., 2020. Review of current progress in non-aqueous aluminum batteries. Renewable and Sustainable Energy Reviews, Volume 133.
Das, S. K., Mahapatra, S. & Lahan, H., 2017. Aluminum-ion batteries: developments and challenges. J. Mater. Chem. A, Volume 5, pp. 6347-6367.
Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.
Elia, G. et al., 2021. An Overview and Prospective on AI and Al-Ion Battery Technologies. Journal of Power Sources, 481 (228870).
Friesen, C. A. & Martinez, J. A. B., 2018. s.l. U.S. Pat. No. 10,090,520.
Friesen, C. A., McDowell, F. & Bautista, M. J. A., 2016. Aluminum-Based Metal-Air Batteries. United States of America, U.S. Pat. No. 9,236,643 B2.
Gan, F. et al., 2019. Low cost ionic liquid electrolytes for rechargeable aluminum/graphite batteries. International Journal of Ionics—The Science and Technology of Ionic Motion, Volume 25, pp. 4243-4249.
Gao, C. & Chen, H., 2018. Preparation Method of Graphene Film Anode Material and Application in Aluminum Ion Battery. United States of America, US20190296353.
Giuseppe, Antonio Elia, Kostiantyn V. Kravchyk, Maksym V. Kovalenko, Joaquin Chacon, Alex Holland, Richard G. A. Wills, 2021. An overview and prospective on AI and Al-ion battery technologies. Journal of Power Resources.
Huang, L.-M. & Chen, C.-H., 2018. Aluminum-Ion Battery. United States of America, U.S. Pat. No. 20180219257.
Leisegang, T. et al., 2019. The Aluminum-Ion attery: A Sustainable and Seminal Concept?. Front Chem, 7 (268).
Levy, N. & Ein-Eli, Y., 2020. Aluminum-ion battery technology: a rising star or a devastating fall?. J Solid State Electrochem, Volume 24, pp. 2067-2071.
Li, C., Zhang, X. & He, W., 2018. Design and modification of cathode materials for high energy density aluminum-ion batteries: a review. J Mater Sci: Mater Electron, Volume 29, pp. 14353-14370.
Miguel, A. et al., 2020. Tough Polymer Gel Electrolytes for Aluminum Secondary Batteries Based on Urea: AlCl3, Prepared by a New Solvent-Free and Scalable Procedure. Polymers, 12(6).
Miller, Y., Tzidon, D. & Yadgar, A., 2021. United States of America, US20210075078.
Mori, R., 2020. Recent Developments for Aluminum-Air Batteries. Electrochemical Energy Reviews, Volume 3, pp. 344-369.
Mukherjee, R. & Koratkar, N. A., 2017. Rechargeable Aluminum Ion Battery. United States of America, U.S. Pat. No. 9,819,220 B2.
Mukherjee, R. et al., 2021. Aqueous aluminum ion batteries, hybrid battery-capacitors, compositions of said batteries and battery-capacitors, and associated methods of manufacture and use. United States of America, U.S. Pat. No. 10,978,734 B2.
Niksa, M. J., Niksa, A. J. & Noscal, J. M., 1990. Primary aluminum-air battery. United States of America, U.S. Pat. No. 4,925,744.
Pan, W. et al., 2022. Non-aqueous Al-ion batteries: cathode materials and corresponding underlying ion storage mechanisms. Rare Met., Volume 41, pp. 762-774.
Sasaki, K., 2015. United States of America, US20150009365.
Stoddart, J., Kim, D., Choi, J. & Yoo, D.-J., 2021. Rechargeable Aluminum Organic Batteries. United States of America, US2020242452.
Su, Y.-S. et al., 2020. Aluminum secondary battery having a high-capacity and high-rate capable cathode and manufacturing method. United States of America, US20180254512.
Wang, D.-Y. et al., 2017. Advanced rechargeable aluminium ion battery with a high-quality natural graphite cathode. Nature Communications, 8(14283).
Wang, D.-Y. et al., 2017. Advanced Rechargeable Aluminum Ion battery with a High-Quality Natural Graphite Cathode. Nature Communications, Volume 8, p. 14283.
Wang, Y. et al., 2023. Solid-state Al-air battery with an ethanol gel electrolyte. Green Energy & Environment, 8(4), pp. 1117-1127.
Yuan, D. et al., 2020. Emerging rechargeable aqueous aluminum ion battery: Status, challenges, and outlooks. Nano Materials Science, Volume 2, pp. 243-263.
Zaromb, S., 1962. The use and behavior of aluminum anodes in alkaline primary batteries. Journal of The Electrochemical Society, 109(12), pp. 1125-1130.

### FIELD OF INVENTION

The present invention generally relates to electricity generation, and more particularly to a method and apparatus for electrical energy storage using rechargeable aluminum-ion electrochemical cells.

### PRIOR ART

An aluminum-ion battery is a rechargeable battery in which aluminum ions serve as charge carriers. Aluminum-ion batteries consist of electrodes emersed in an electrolyte. The obvious material for the anode is aluminum, an alloy of aluminum, or a compound of aluminum. Common materials for the cathode (Pan, et al., 2022) include: carbon-based materials such as graphite, amorphous carbons, porous carbons (Li, et al., 2018). Common materials for the electrolyte include CO(NH₂)₂ or carbamide (also called urea), sea-salt, and acidic room temperature non-aqueous ionic liquids (IL). The ionic liquid is made of aluminum chloride (AlCl₃) and 1-ethyl-3-methylimidazolium chloride [EmIm]Cl (Miguel, et al., 2020). The use of the ionic liquid as an electrolyte prevents passivation.

Aluminum-ion batteries are promising alternatives to the lithium-ion batteries commonly used in portable electronics, electric vehicles, and stationary energy for homes, commercial buildings, and grid-scale applications. Key advantages of aluminum-ion batteries include the relatively low-cost, high-energy density, safety, and long cycle life (Leisegang, et al., 2019). Recent investigations on aluminum-ion batteries have been conducted by:
(Wang, et al., 2017) who presented an advanced rechargeable aluminum-ion battery with a high-quality natural graphite cathode.
(Das, et al., 2017) who detailed developments and challenges faced by aluminum-ion batteries. The authors focus on the electrode materials, innovative perspectives, and future research efforts on rechargeable aluminum-ion batteries.
(Gan, et al., 2019) who designed a high-performance rechargeable aluminum battery using a graphite cathode and AlCl₃/Et₃NHCl ionic liquid electrolyte.
(Levy & Ein-Eli, 2020) who discussed the potential of aluminum-ion batteries as a cost-effective energy storage technology for renewable energy sources.
(Craig, et al., 2020) who reviewed current progress in non-aqueous aluminum batteries. The authors conclude that graphite-based positive electrodes, especially cheap and abundant graphite flakes, offer the best overall performance because of the stability and high discharge potential.
(Yuan, et al., 2020) who described the status, challenges, emerging, and outlooks of emerging rechargeable aqueous aluminum-ion battery.
(Elia, et al., 2021) who reviewed developments in different classes of aluminum-centered batteries. The focus was on “aluminum electrolyte chemistry based on “chloroaluminate melts, deep eutectic solvents, polymers, and chlorine-free formulations.”

Patents which taught implementations of the aluminum-ion batteries include:
(Archer, et al., 2014) which teaches an aluminum ion battery using an aluminum anode, a vanadium oxide material cathode, and an ionic liquid electrolyte. The vanadium oxide material cathode comprises a monocrystalline orthorhombic vanadium oxide material.
(Mukherjee & Koratkar, 2017) which describes a rechargeable battery using a solution of an aluminum salt as an electrolyte.
(Huang & Chen, 2018) which describes an aluminum-ion battery using an electrolyte comprising of an aluminum halide, a solvent and a compound made from alkyl or fluoroalkyl group.
(Gao & Chen, 2018) which discloses a method of preparing a graphene anode material by coating a graphene oxide solution on a substrate, drying, removing the substrate, performing reduction, and obtaining a graphene film with ultra-high conductivity.
(Mukherjee, et al., 2021) which describes an aqueous aluminum ion battery with improved charge storage capacity.
(Stoddart, et al., 2021) which discloses rechargeable aluminum batteries using cathodic phenanthrenequinone unit and a graphite flake.
(Azimi & Ng, 2023) which describes aluminum-ion battery technology with an electrolyte consisting of an aluminum trichloride (Al—Cl3)/trimethylamine hydrochloride ionic liquid, aluminum metal as the anode material, and a compatible cathode active material.
(Su, et al., 2020) which describes an aluminum-ion battery with a cathode comprising of a layer of recompressed exfoliated graphite or carbon material that is oriented in such a manner that the layer has a graphite edge plane in direct contact with the electrolyte and facing the separator.
(Caban-Acevado & Yushin, 2023) which describes rechargeable batteries with alkali metal ion cathodes, aluminum metal-based anodes and displacement electrolyte.

### BACKGROUND OF THE INVENTION

Aluminum-ion batteries are emerging as better alternatives to lithium-ion batteries, the leading choice for wireless devices, computers, electric mobility, and small-scale to grid-scale stationary energy storage applications. The advantages of aluminum-ion batteries over lithium-ion batteries include: cost-effectiveness of aluminum because of its abundance in the Earth's crust; safety because aluminum-ion batteries are less prone to thermal runaway and fire hazards; significantly higher theoretical energy density (1060 Wh/kg, versus 406 Wh/kg theoretical limit for lithium-ion batteries); high recyclability of aluminum; longevity due to the large number of charging and discharging cycles of aluminum-ion batteries.

This invention uses the advantages inherent in the electrochemistry of aluminum-ion batteries to teach the construction of an ultra-low-cost solid-state rechargeable battery. The electrodes maximize electrochemical reaction surfaces. The dual-pole cells are easy to build. The dual-pole cell components are affordable, and the materials are widely available.

### SUMMARY OF THE INVENTION

According to the present invention there is provided a method of storing electrical energy using an electrochemical dual-pole cell comprising circular exterior container discs, coiled anodic aluminum wire discs, graphite discs, and solid electrolyte discs based on a compound mixture of urea, sea-salt, and sodium silicate.

An advantage of the present invention is the provision of a method and apparatus for converting electricity into chemical energy stored in an aluminum-ion cell.

Still another advantage of the present invention is the provision of a method and apparatus for electricity storage which utilizes dual solid ionic electrolyte discs.

Still another advantage of the present invention is the provision of a method and apparatus for electricity storage which utilizes a disc of coiled anodic aluminum wire.

Still another advantage of the present invention is the provision of a method and apparatus for electricity storage which utilizes two graphite discs.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Dual-Pole Cell;

FIG. 2 is an illustration of the vertical cross-section of the Dual-Pole Cell;

FIG. 3 is an illustration of the anodic coiled aluminum wire of the Dual-Pole Cell;

FIG. 4 is an illustration of the steps involved in the construction of the Dual-Pole Cell.

FIG. 5 is an illustration of stacking of Dual-Pole Cells to form a Cylindrical Power Module.

FIG. 6 is an illustration of the isometric view of Cylindrical Power Modules arranged to form a Battery Power Pack.

### DETAILED DESCRIPTION OF THE INVENTION

It should be appreciated that while a preferred embodiment of the present invention will be described with reference to aluminum-ion electrochemical cell, other metal-ion electrochemical cells are also suitable for use in connection with the present invention. These include zinc-ion, iron-ion, magnesium-ion, lithium-ion, calcium-ion, sodium-ion, potassium-ion, and tin-ion electrochemical cells.

In accordance with a preferred embodiment, the present invention teaches the storage of electricity using a dual-pole electrochemical cell comprising a) two circular exterior discs; b) a disc of coiled anodic wire; c) two cathodic graphite-based discs; and d) an electrolyte based on a mixture of urea, sea-salt, and sodium silicate.

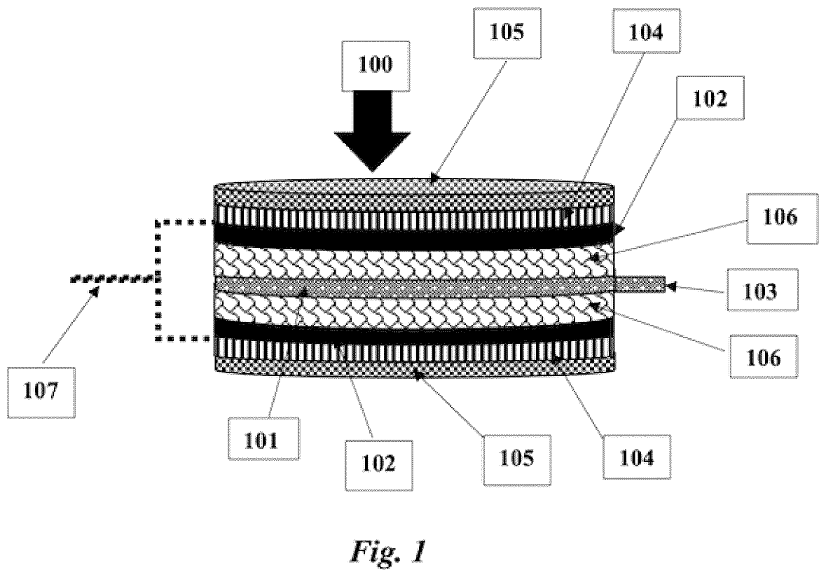

Referring now to the drawings wherein the showings are for the purposes of illustrating a preferred embodiment of the invention only and not for purposes of limiting same, FIG. 1 is an illustration of the isometric view of dual-pole cell 100. At the middle of the dual-pole cell is aluminum anode 101, sandwiched by layers of solid electrolyte discs 102, cathodes 102, current collectors 104, and exterior covering 105. Positive terminals 107 are attached to current collectors 104.

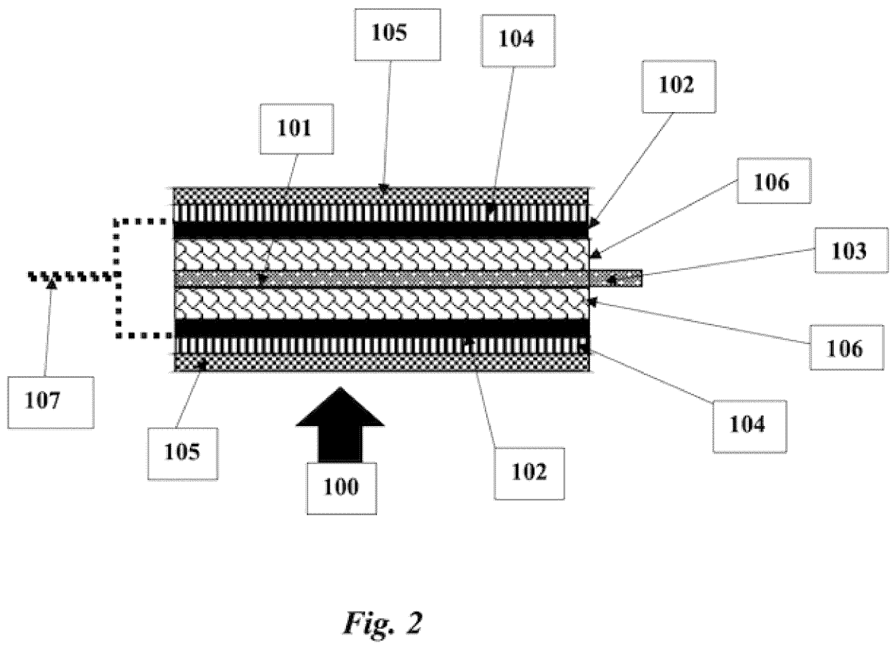

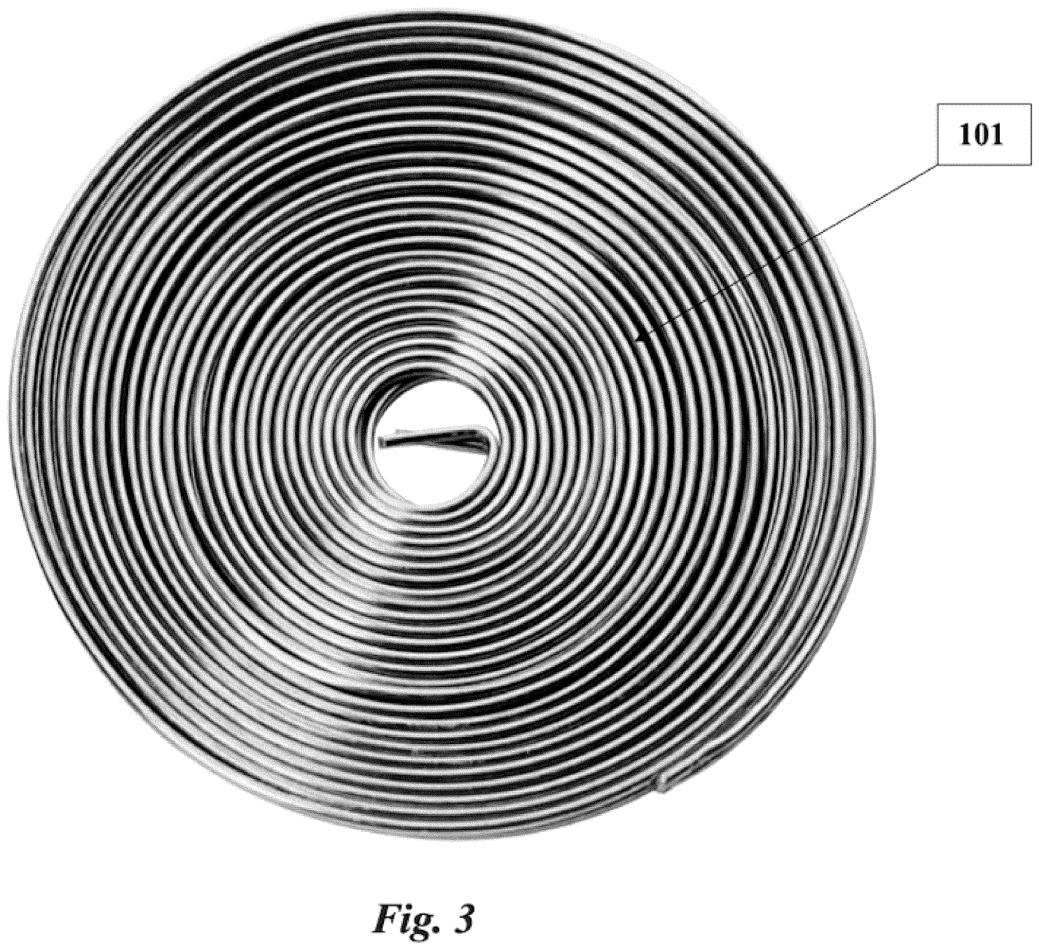

Referring now to FIG. 2 and FIG. 3:
1. Aluminum Anode 101. According to the preferred embodiment of this patent, anode 101 is pure aluminum in the form of a coiled aluminum wire disc.
2. Cathode 102. According to the preferred embodiment of this patent, cathode 103 is a graphite sheet disc or a cellulosic material carbonized by doping with carbon ink derived from graphite powder and Acrylic Glazing Liquid.
3. Negative Terminal 103: According to the preferred embodiment of this patent, negative terminal 103, is the protruding end of coiled aluminum wire anode 101.
4. Current Collector 104. According to the preferred embodiment of this patent, current collector 104 consists of a conductive copper sheet, copper foil, or mesh of copper into a circular shape.
5. Exterior Covering 105. According to the preferred embodiment of this patent, exterior disc 105 consists of a conductive copper foil, or a polycarbonate plastic material.
6. Solid Electrolyte Discs 106. According to this invention, electrolyte 106 is formulated by mixing x parts by volume of powdery urea (NH₂)₂CO with y parts by volume of sea-salt, with z parts by volume of sodium silicate (water glass). The mixture is stirred until a uniformly smooth gel is achieved. Solid Electrolyte Discs 106 are formed by molding the fresh electrolyte in a Petri dish, or soaking super absorbent cellulosic materials with the freshly made electrolyte.
7. Positive Terminal 107: According to the preferred embodiment of this patent, positive terminal 107, is a thin nickel strip (thickness 0.15 mm, width 8 mm) attached to current collector 104.

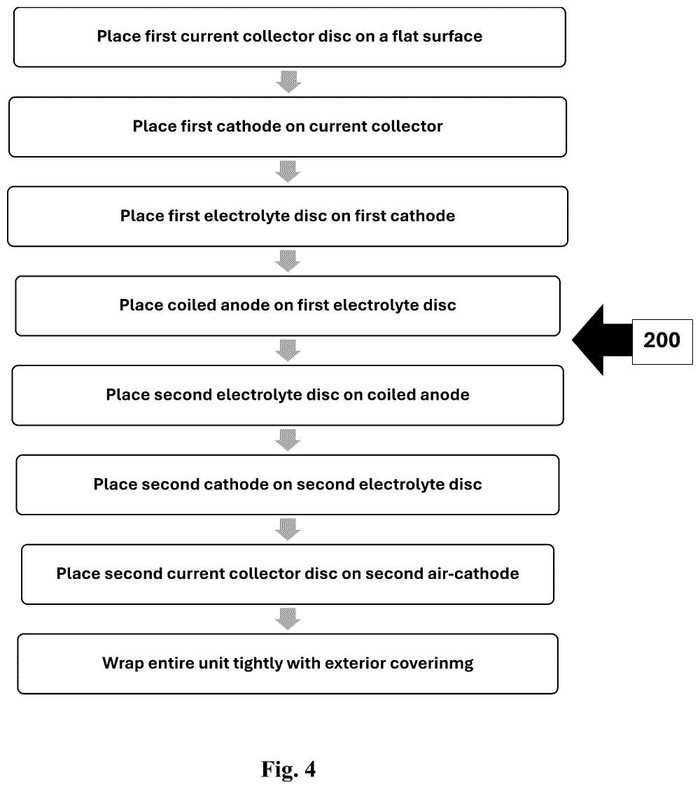

Referring now to FIG. 4, the steps 200 involved in the construction of the Dual-Pole-Cell 100 are:
1. Place first current collector disc 104 on a flat surface.
2. Place first cathode 102 on current collector 104.
3. Place first electrolyte disc 106 on first cathode 102.
4. Place coiled aluminum anode 101 on first electrolyte disc 106.
5. Place second electrolyte disc 106 on coiled aluminum wire anode 101.
6. Place second cathode 102 on second electrolyte disc 106.
7. Place second current collector disc 104 on second cathode 102.
8. Wrap entire unit tightly with exterior covering 105.
9. Ensure positive terminal 109. and negative terminal 110 are aligned to the same direction.

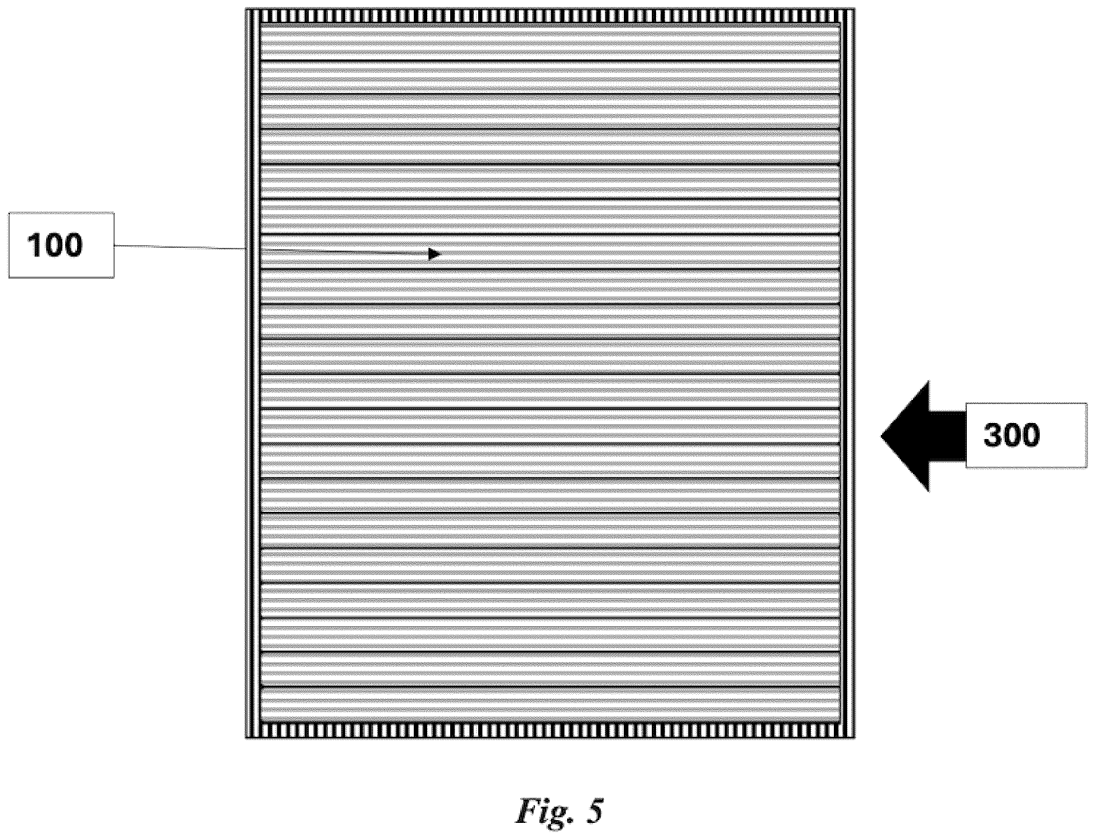

Referring now to FIG. 5:
1. Dual-Pole Cells 100 are stacked to form a Cylindrical Power Module 300.
2. Dual-Pole Cells 100 are connected in series and/or parallel to achieve specific power and energy capacities for Cylindrical Power Module 300.

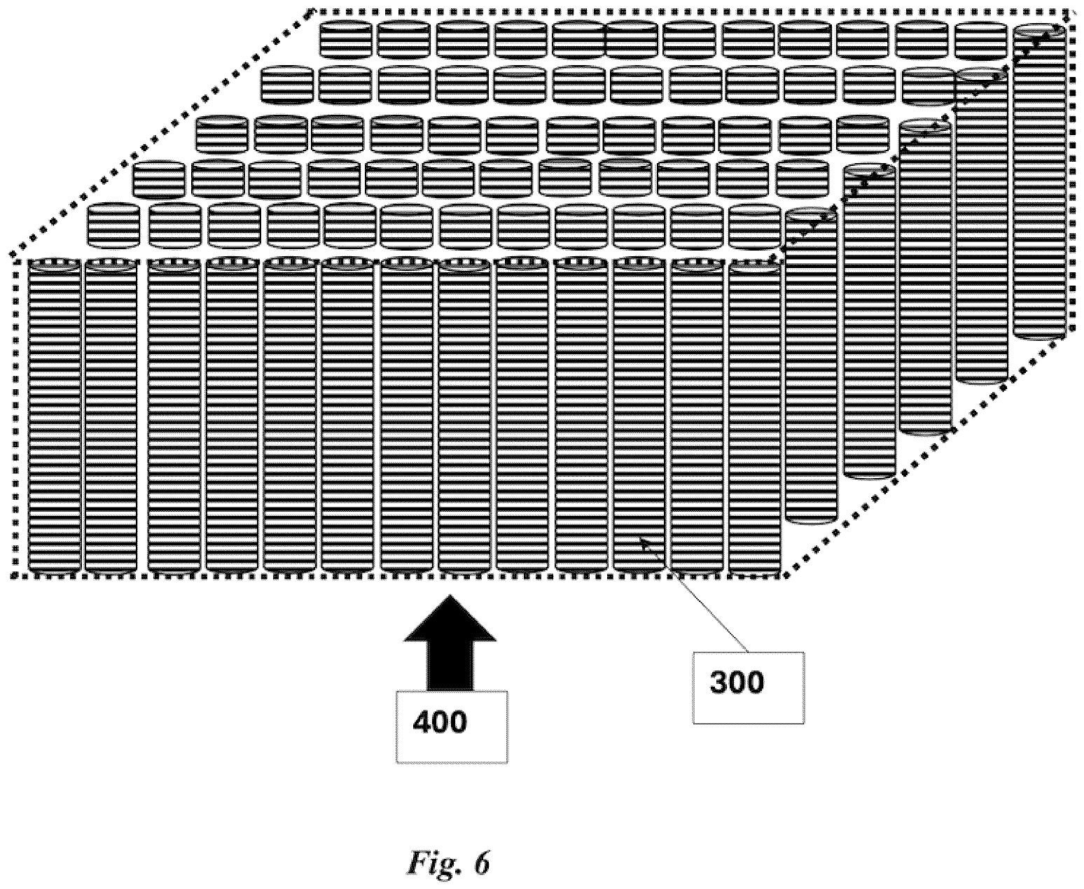

Referring now to FIG. 6:
1. Cylindrical Power Modules 300 are arranged in a rectangular formation to obtain Prismatic Battery Pack 400.
2. Cylindrical Power Modules 300 are connected in series and/or parallel to achieve specific power and energy capacities for Battery Pack 400.

### EXAMPLE

To establish the characteristics of the fuel dual-pole-cell, according to the invention disclosed herein, a discharge test was conducted on a dual-pole-cell of distinct size configuration. In the following example:
Diameter of Dual-Pole Cell: 100 mm
Thickness of Dual-Pole Cell: 17 mm
Anode: 90 mm diameter coiled Gauge 12 aluminum wire
Cathode: Carbon Graphite Disk (100 mm diameter; 5 mm thick)
Electrolyte: 2×100 mm diameter×2 mm thick solid-state ionic electrolyte prepared from a mixture of 10 ml of urea, 10 ml of sea-salt, and 240 ml of sodium silicate.
Current Collector: 2×100 mm diameter×0.5 mm thick) pure copper round.
Positive Terminal: Single nick strip attached to both current collectors
Negative Terminal: Outer end of anodic aluminum coil
Open Circuit Voltage: 2.5V
Discharge Current: 100 mA
Test duration: 11,467 minutes
Current Capacity: 19,111 mAh
Energy Produced: 10,608 mWh
Average Operating Voltage: 0.6V

The present invention has been described with reference to a preferred embodiment. Obviously, modifications and alterations will occur to others upon a reading and understanding of this specification. It is intended that all such modifications and alterations be included as far as they come within the scope of the appended claims or the equivalents thereof.

1. According to the present invention there is provided a method of storing electrical energy using an electrochemical dual-pole cell comprising circular discs as exterior container, an anode consisting of aluminum wire, graphite-based discs as cathode, and electrolyte based on a compound mixture of urea, sea-salt, and sodium silicate.

2. A method according to claim 1, wherein the cathode consists of two graphite discs.

3. A method according to claim 1, wherein the cathode consists of two discs obtained from super absorbent cellulosic material carbonized by doping with carbon ink derived from graphite powder and Polyvinyl Acetate (PVA), a vinyl polymer.

4. A method according to claim 1, wherein the anode is a coiled disc of aluminum wire.

5. A method according to claim 1, wherein the electrolyte is solid, consisting of a compound mixture of urea, sea-salt, and sodium silicate.

6. A method according to claim 1, wherein the membrane separators are cellulosic sheets.

7. An apparatus according to claim 1, wherein the fuel dual-pole cells are stacked to form a Cylindrical Power Module.

8. An apparatus according to claim 7, wherein the Cylindrical Power Modules are arranged in rectangular grid formation and connected in series and parallel to form a Battery Power Pack.
